(19) United States
(12) Patent Application Publication
(10) Pub. No.: US 2021/0256494 A1
(43) Pub. Date: Aug. 19, 2021

(54) PAYMENT TERMINAL AND CONTROL METHOD FOR A PAYMENT TERMINAL

(71) Applicant: TOSHIBA TEC KABUSHIKI KAISHA, Tokyo (JP)

(72) Inventor: Nobuaki SUGIURA, Tagata Shizuoka (JP)

(21) Appl. No.: 16/951,957

(22) Filed: Nov. 18, 2020

(30) Foreign Application Priority Data
Feb. 17, 2020 (JP) 2020-024535

(51) Int. Cl. G06Q 20/32; G06Q 20/20

(52) U.S. Cl. CPC G06Q 20/326; G06Q 20/3276; G06Q 20/209; G06Q 20/204

(57) ABSTRACT

In accordance with an embodiment, a payment terminal includes a display, a memory device, and a controller. Upon payment for a commodity to be purchased by a customer, information associated with one or more types of payment applications and code symbols are read from the memory device, and the display is caused to display the read information associated with the payment applications and the read code symbols such that the customer is capable of recognizing the read information associated with the payment applications and the read code symbols.

### CROSS-REFERENCE TO RELATED APPLICATION

This application is based upon and claims the benefit of priority from the prior Japanese Patent Application No. 2020-024535, filed on Feb. 17, 2020, the entire contents of which are incorporated herein by reference.

### FIELD

An embodiment described here generally relates to a payment terminal and a control method for a payment terminal.

### BACKGROUND

In recent years, a customer sometimes performs payment for purchased commodities at a store such as a supermarket, a convenience store, and a high-volume sales store by using a mobile terminal such as a smartphone, a mobile phone, and a personal digital assistant (PDA). For such payment using the mobile terminal, the customer installs an application used for payment in a payment terminal in advance. For check-out, the customer captures an image of a symbol such as a two-dimensional code presented by the store by using a camera function provided in the mobile terminal, and then the payment application causes the mobile terminal to access a site of the application operator and performs payment processing associated with the commodity purchase at the store.

By the way, since there are many companies that provide such payment applications, it is difficult for customers to obtain information on which company's payment application can be used at the store.

### BRIEF DESCRIPTION OF THE DRAWINGS

FIG. 1 is a diagram showing a terminal payment system.

FIG. 2 is a perspective view showing a POS terminal according to a first embodiment.

FIG. 3 is a block diagram showing a hardware configuration of the POS terminal.

FIG. 4 is a memory map showing a configuration of a terminal payment information unit.

FIG. 5 is a functional block diagram showing a functional configuration of the POS terminal.

FIG. 6 is a flowchart showing control processing of the POS terminal.

FIG. 7 is a diagram showing an example of a display screen of a display of the POS terminal.

FIG. 8 is a diagram showing an example of another display screen of the display of the POS terminal.

FIG. 9 is a diagram showing an example of still another display screen of the display of the POS terminal.

FIG. 10 is a functional block diagram showing a functional configuration of a POS terminal according to a second embodiment.

FIG. 11 is a flowchart showing control processing of the POS terminal.

FIG. 12 is a diagram showing an example of a display screen of a display of the POS terminal.

### DETAILED DESCRIPTION

In accordance with one embodiment, a payment terminal performs commodity data processing for payment for a commodity to be purchased by a customer and payment processing for the commodity. The payment terminal includes a display, a memory device, and a controller. The display displays information to the customer. The memory device stores information associated with one or more types of payment applications for payment, which are usable for the payment, and code symbols each including at least information for accessing a site of the payment application in association with each other. The controller reads, upon payment for the commodity, from the memory device the information associated with the one or more types of payment applications. The controller causes the display to display the read information associated with the payment application such that the customer is capable of recognizing the read information associated with the payment application. The controller determines whether or not one payment application has been designated from the displayed information associated with the payment application via the display. The controller reads, in a case of determining that the one payment application has been designated, from the memory device the code symbol associated with the payment application, and causes the display to display the read code symbol.

Hereinafter, an information processing apparatus and a control method therefor according to embodiments will be further described with reference to the drawings. The same reference signs in the drawings will denote the same or similar portions.

### First Embodiment

Hereinafter, a first embodiment will be described in detail with reference to the drawings. In the first embodiment, the description will be given showing a point of sales (POS) terminal as an example of the payment terminal. It should be noted that the first embodiment is not limited to the following descriptions. Further, the same reference signs in the drawings will denote the same or similar portions.

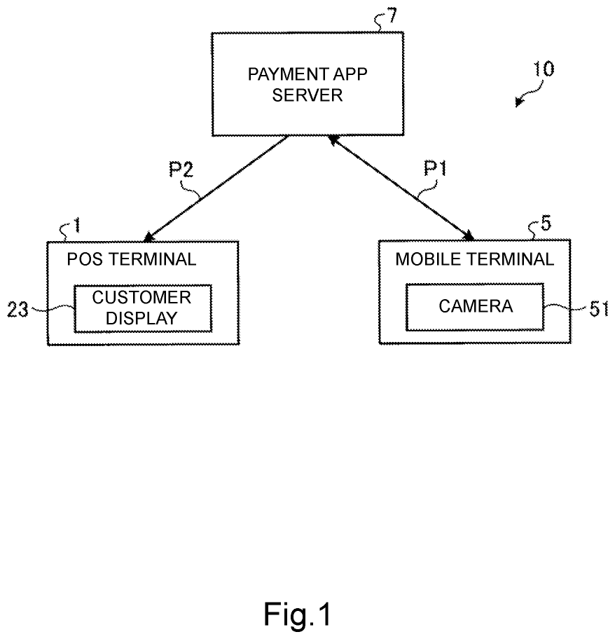

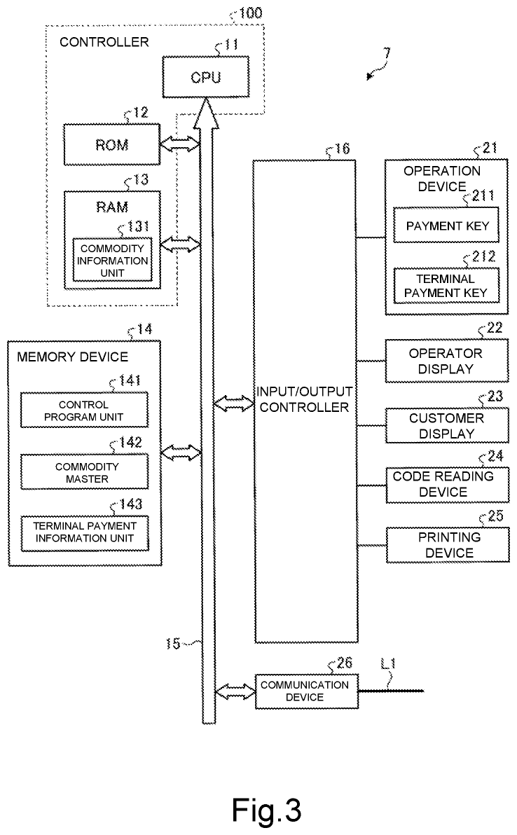

First, a mechanism of payment (hereinafter, referred to as “application payment”) using a payment application installed in a mobile terminal will be described. FIG. 1 is a system diagram showing a terminal payment system. A terminal payment system 10 includes a POS terminal 1, a mobile terminal 5, and a payment app server 7. The POS terminal 1 shown in FIG. 1 is set in a store. The POS terminal 1 performs commodity data processing (also referred to as sales registration processing) for payment for a commodity purchased by a customer and payment processing in a transaction with the customer who purchases the commodity at the store. The POS terminal 1 captures an image of a symbol such as a barcode attached to the commodity sold in the transaction and obtains a commodity code for identifying the corresponding commodity. The commodity data processing performed by the POS terminal 1 includes processing of displaying commodity information (commodity name, price, and the like) of the commodity read by the POS terminal 1 on the basis of the obtained commodity code and storing the commodity information in a RAM 13 (see FIG. 3) or the like. It should be noted that the POS terminal 1 may optically read the image of the symbol attached to the commodity and obtain the corresponding commodity code. Further, the payment processing performed by the POS terminal 1 includes processing of displaying a total amount of money associated with the transaction, processing of calculating and displaying change on the basis of money received from the customer, and processing of instructing a change machine to provide the change on the basis of the commodity data stored in the RAM 13 or the like in the commodity data processing. Further, the payment processing includes processing of issuing a receipt on which the commodity information and payment information (total amount, received amount, change amount, and the like) subjected to the commodity data processing (sales registration processing) are printed. The POS terminal 1 includes a customer display 23 that displays information to the customer.

The mobile terminal 5 shown in FIG. 1 is a smartphone, a mobile phone, or a PDA carried by the customer who visits the store, for example. The mobile terminal 5 includes a built-in camera 51. The mobile terminal 5 downloads, installs, and stores a payment application for performing application payment from a site of a company that operates the payment application. The mobile terminal 5 is connected to the payment app server 7 via a communication line P1. The mobile terminal 5 transmits to the payment app server 7 amount information of a payment amount to be paid by the customer in association with the transaction.

The payment app server 7 shown in FIG. 1 is connected to the mobile terminal 5 via the communication line P1 which is a wireless communication line, for example. The payment app server 7 receives the amount information from the mobile terminal 5 and performs payment processing of paying an amount corresponding to the amount information from a bank account of the customer, for example.

Further, the payment app server 7 is connected to the POS terminal 1 via a communication line P2 which is a wireless or wired dedicated line, for example. When the payment app server 7 performs the above-described payment processing or determines to perform the payment processing, the payment app server 7 communicates withdrawal information (amount paid (to be paid) from the bank account) to the POS terminal 1. When the POS terminal 1 receives the withdrawal information from the payment app server 7, the POS terminal 1 performs the above-mentioned payment processing and prints the withdrawal information on a receipt handed to the customer. A store operator (store employee) hands the receipt to the customer.

Next, how to perform application payment using the payment application in the mobile terminal 5 will be described. Here, a case where application payment using the payment application is performed after commodities are purchased at a store and commodity data processing for the commodities is performed using the POS terminal 1 or the like will be described as an example. The POS terminal 1 displays a code symbol including amount information, which will be described later, on the customer display 23 (display unit) (see FIG. 3).

The customer reads the code symbol (two-dimensional code or the like) displayed on the customer display 23 by using a camera function provided in the mobile terminal 5 and the payment application. The displayed code symbol (i.e., code symbol the image of which is captured by the mobile terminal 5) includes at least access information (address information or the like) to the site operated by the company. In the embodiment, the code symbol includes the access information to the site and the amount of money (total amount of purchased commodities+tax amount) paid to the store by the customer in the transaction. The amount information included in the imaged code symbol is displayed on the mobile terminal 5. It should be noted that the code symbol does not need to include the amount information. In this case, the customer or the store employee inputs the amount information displayed on the customer display 23 by using an operation device 21 (see FIG. 3).

Next, the customer and the store employee confirm the amount information displayed on the mobile terminal 5. The customer operates a transmission button to the payment app server 7, the transmission button being provided in the mobile terminal 5. Then, information for payment including the amount information displayed on the mobile terminal 5 is transmitted from the mobile terminal 5 to the payment app server 7.

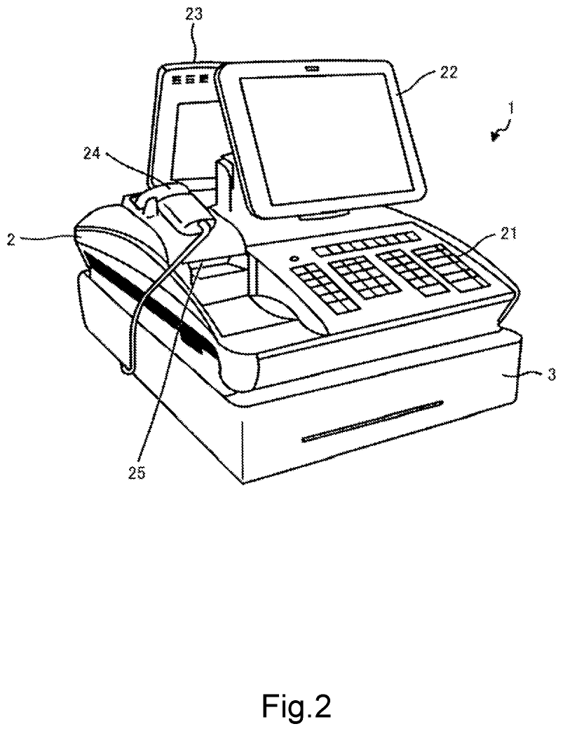

Next, the POS terminal 1 will be described. FIG. 2 is a perspective view showing the outer appearance of the POS terminal 1 according to the first embodiment as viewed from the store employee. In FIG. 2, the POS terminal 1 includes a main body 2 and a money storage box 3. The money storage box 3 has a drawer, and stores cash such as bills and money and securities such as gift certificates received from the customer, change that is provided to the customer, and the like.

The main body 2 of the POS terminal 1 includes the operation device 21 including a keyboard including number keys, touch keys, and the like, an operator display 22 that displays information to an operator as a person who operates it, and the customer display 23 that displays information to a customer who shops. Further, the main body 2 includes a code reading device 24 that reads a code symbol such as a barcode and a two-dimensional code attached to a commodity. The code reading device 24 includes a charge coupled device (CCD) image sensor or the like to optically read or image the code symbol attached to the commodity. The POS terminal 1 analyzes the read code symbol and obtains a commodity code for identifying the commodity. Further, the main body 2 of the POS terminal 1 includes a printing device 25 that prints commodity information and payment information of a commodity to be sold and issues the printed commodity information and the payment information as a receipt.

Hereinafter, a hardware configuration of the POS terminal 1 will be described. FIG. 3 is a block diagram showing a hardware configuration of the POS terminal 1. As shown in FIG. 3, the POS terminal 1 includes a controller 100, a memory device 14, and the like. The controller 100 includes a central processing unit (CPU) 11, a read only memory (ROM) 12, and a random access memory (RAM) 13. The CPU 11 performs control. The ROM 12 stores various programs. The RAM 13 expands programs and various types of data. The memory device 14 stores various programs. The CPU 11, the ROM 12, the RAM 13, and the memory device 14 are connected to each other via a bus 15. The controller 100 performs control processing related to the POS terminal 1 to be described later such that that the CPU 11 operates in accordance with a control program stored in the ROM 12 or the memory device 14 and expanded in the RAM 13.

The RAM 13 includes a commodity information unit 131. The commodity information unit 131 stores commodity information (commodity price, commodity name, and the like) of the commodity subjected to the commodity data processing.

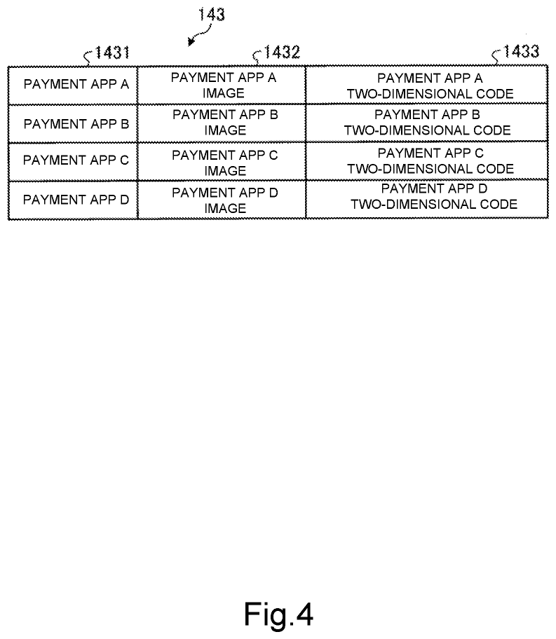

The memory device 14 is a non-volatile memory such as a hard disc drive (HDD) and a flash memory in which the stored information is retained even when powered off. The memory device 14 includes a control program unit 141, a commodity master 142, and a terminal payment information unit 143. The control program unit 141 stores a control program for controlling the POS terminal 1. The commodity master 142 stores commodity information associated with the commodity for each commodity code for identifying the commodity. The terminal payment information unit 143 stores, for each payment application, information associated with the payment application that can be used for payment at the store. The terminal payment information unit 143 will be described later with reference to FIG. 4.

Further, the controller 100 is connected to the operation device 21, the operator display 22, the customer display 23, the code reading device 24, and the printing device 25 via the bus 15 and an input/output controller 16. The operation device 21 is a keyboard and the like for operating the POS terminal 1 and includes a payment key 211 and a terminal payment key 212. The payment key 211 is operated by the operator when the commodity data processing associated with the commodity purchased by the customer is completed and the processing proceeds to the payment processing. The terminal payment key 212 is operated by the operator when the customer performs application payment through the mobile terminal 5 by using the payment application.

The operator display 22 is, for example, a display including a liquid crystal display and displays information to the operator who operates the POS terminal 1. The customer display 23 is, for example, a display including a liquid crystal display and displays information to the customer who purchases the commodity. It should be noted that a touch panel that is the operation device 21 is disposed on the surface of the customer display 23. Further, the input/output controller 16 receives an instruction from the controller 100, and controls the operation device 21, the operator display 22, the customer display 23, the code reading device 24, and the printing device 25. Hereinafter, although the input/output controller 16 actually performs the processing, it is assumed that the controller 100 performs the processing for the sake of description.

Further, the controller 100 is connected to a communication device 26 via the bus 15. The communication device 26 is connected to the payment app server 7 through the communication line P2 and transmits and receives information to/from the payment app server 7.

Next, the terminal payment information unit 143 of the memory device 14 will be described. FIG. 4 is a memory map showing a configuration of the terminal payment information unit 143. As shown in FIG. 4, the terminal payment information unit 143 includes a payment app unit 1431, a payment app image unit 1432, and a payment app code unit 1433.

The payment app unit 1431 of the terminal payment information unit 143 shown in FIG. 4 stores payment application information such as a payment application code for identifying a payment application that can be used at the store for each payment application. In the embodiment, payment application information for identifying four types of payment applications of a payment app A, a payment app B, a payment app C, and a payment app D, is stored as shown in FIG. 4. That is, in the embodiment, the four types of payment applications of the payment app A, the payment app B, the payment app C, and the payment app D can be used at the store. It should be noted that a payment application of the stored payment applications, in which information such as a flag indicating that it is usable is stored in association with the payment application, may be used as the payment application that can be used at the store.

The payment app image unit 1432 of the terminal payment information unit 143 shown in FIG. 4 stores image information distinctively showing each of payment applications respectively associated with pieces of payment application information stored in the payment app unit 1431, in association with each of pieces of payment application information. Based on the displayed image information, the customer can individually recognize which payment application it is.

The payment app code unit 1433 of the terminal payment information unit 143 shown in FIG. 4 stores code symbols indicating two-dimensional codes respectively associated with the pieces of payment application information stored in the payment app unit 1431. Each code symbol stores access information (e.g., address) to the payment app server 7 set to the site for operating each payment application.

In the embodiment, this code symbol includes an area indicating the access information and an area indicating the amount information of the payment amount to be paid by the customer. The stored code symbol has already stored the access information to the payment app server 7. For displaying the code symbol on the customer display 23, the POS terminal 1 reads the code symbol stored in the payment app code unit 1433 of the terminal payment information unit 143 and generates a code symbol to which the amount information is added. Then, the POS terminal 1 displays the code symbol to which the amount information is added on the customer display 23. The mobile terminal 5 obtains the access information to the payment app server 7 and the amount information by capturing an image of the displayed code symbol with the camera 51. The mobile terminal 5 transmits the obtained amount information to the address indicated by the obtained access information. The payment app server 7 receives the amount information from the mobile terminal 5 and performs payment processing based on the amount information.

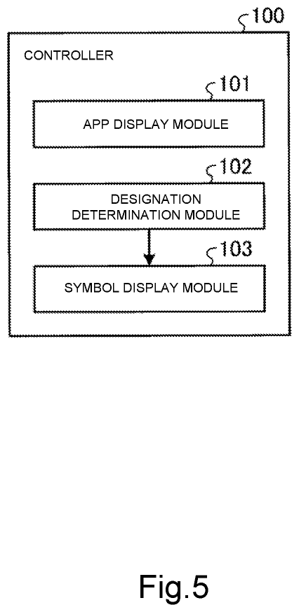

Hereinafter, a functional configuration of the POS terminal 1 according to the first embodiment will be described. FIG. 5 is a functional block diagram showing the functional configuration of the POS terminal 1. The controller 100 shown in FIG. 3 functions as an app display module 101, a designation determination module 102, and a symbol display module 103 in accordance with the control program stored in the ROM 12 or the control program unit 141 of the memory device 14.

The app display module 101 of the controller 100 shown in FIG. 5 displays information regarding one or more types of usable payment applications on the customer display 23 in a recognizable manner upon payment of the commodities to be purchased. Specifically, the app display module 101 reads payment application images associated with one or more types of payment applications that can be used at the store from the payment app image unit 1432 of the terminal payment information unit 143 and displays the payment application images on the customer display 23 such that that the customer can recognize the payment application images.

The designation determination module 102 of the controller 100 shown in FIG. 5 determines whether or not one payment application of the displayed payment applications has been designated. Specifically, the designation determination module 102 determines whether or not one payment application of the payment application images associated with the payment applications displayed on the customer display 23 has been designated by the customer.

The symbol display module 103 of the controller 100 shown in FIG. 5 displays, on the customer display 23, a symbol including at least information for accessing the site of the payment application in a case where it is determined that one payment application has been designated. Specifically, in a case where the designation determination module 102 determines that one payment application image has been designated, the symbol display module 103 reads the code symbol associated with the designated payment application from the payment app code unit 1433 of the terminal payment information unit 143 and displays the code symbol on the customer display 23.

The symbol display module 103 of the controller 100 favorably displays the read code symbol in place of all the payment application images displayed by the app display module 101. That is, the symbol display module 103 favorably deletes all the payment application images displayed by the app display module 101 from the customer display 23 and instead displays the read code symbol on the customer display 23. It should be noted that the symbol display module 103 may display the read code symbol in association with the payment application image of the payment application determined by the designation determination module 102 to have been designated. In this case, the payment application images of the payment applications not designated may be deleted from the customer display 23 or do not need to be deleted from the customer display 23.

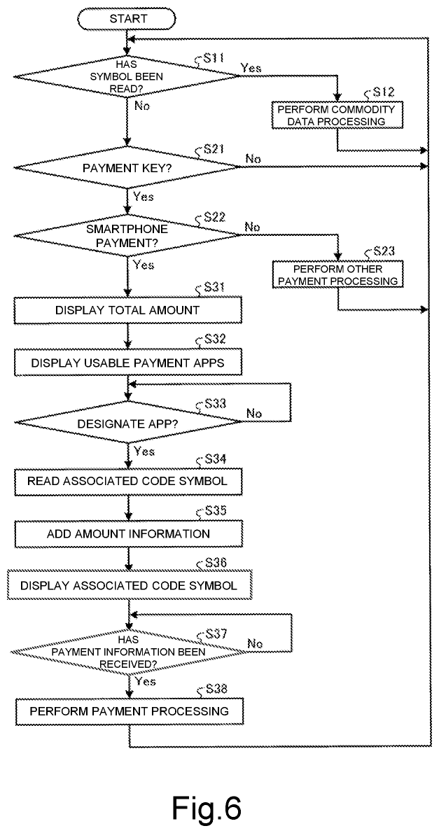

Hereinafter, the control of the POS terminal 1 according to the first embodiment will be described. FIG. 6 is a flowchart showing the control processing of the POS terminal 1. As shown in FIG. 6, in Step S11, the controller 100 of the POS terminal 1 determines whether or not the code reading device 24 has read the code symbol attached to the commodity. In a case where the controller 100 determines that the code symbol attached to the commodity has been read (YES in Step S11), the processing of the controller 100 proceeds to Step S12. In Step S12, the controller 100 analyzes the read code symbol to obtain a commodity code for identifying the commodity. The controller 100 performs commodity data processing on the basis of the obtained commodity code. Specifically, as the commodity data processing, the controller 100 performs processing of searching the commodity master 142, reading the commodity information associated with the commodity, and storing the commodity information in the commodity information unit 131. Then, the processing of the controller 100 returns to Step S11.

Further, in a case where the controller 100 determines that the code symbol attached to the commodity has not been read (No in Step S11), the processing of the controller 100 proceeds to Step S21. In Step S21, the controller 100 determines whether or not the payment key 211 has been operated. In a case where the controller 100 determines that the payment key 211 has been operated (YES in Step S21), the processing of the controller 100 proceeds to Step S22. In Step S22, the controller 100 determines whether or not the terminal payment key 212 has been operated. In a case where the controller 100 determines that the terminal payment key 212 has been operated (YES in Step S22), the processing of the controller 100 proceeds to Step S31. In Step S31, the controller 100 displays the amount information associated with the payment amount to be paid by the customer on the customer display 23. It should be noted that in Step S31, the same amount information may be also displayed on the operator display 22. The customer recognizes the amount information displayed on the customer display 23.

Next, in Step S32, the app display module 101 of the controller 100 reads the payment application images associated with the payment applications that can be used at the store from the payment app image unit 1432 of the terminal payment information unit 143, and displays the payment application images on the customer display 23 such that that the customer can recognize the payment application images. It should be noted that the app display module 101 of the controller 100 may also display the same payment application images on the operator display 22. The customer recognizes the payment applications that can be used at the store by viewing the payment application image displayed on the customer display unit 23. Then, the customer designates one payment application by touching a position on the touch panel, at which a payment application image of the payment application images displayed on the customer display 23 is displayed, the payment application image being associated with a payment application to be used by the customer.

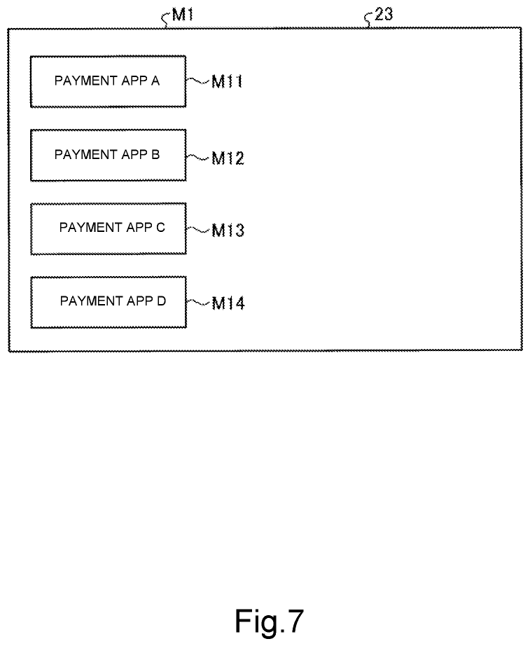

FIG. 7 is a diagram showing an example of the payment application images displayed on the customer display 23 in Step S32. As shown in FIG. 7, the app display module 101 of the controller 100 displays a screen M1 on the customer display 23. On the screen M1, payment application images showing the payment applications that can be used at the store are displayed. In the embodiment, the customer display 23 displays, on the screen M1, a payment app A image M11 showing the payment app A, a payment app B image M12 showing the payment app B, a payment app C image M13 showing the payment app C, and a payment app D image M14 showing the payment app D.

The description of FIG. 6 will be continued. In Step S33, the designation determination module 102 of the controller 100 determines whether or not one payment application has been designated from the payment application images associated with the one or more types of payment applications displayed on the customer display 23. The controller 100 waits until one payment application is designated (No in Step S33). In a case where the controller 100 determines that one payment application has been designated (YES in Step S33), the processing of the controller 100 proceeds to Step S34. In Step S34, the controller 100 reads the code symbol associated with the designated payment application from the payment app code unit 1433 of the terminal payment information unit 143. Then, in Step S35, the controller 100 generates a code symbol in which information on the payment amount to be paid by the customer is added to the read code symbol. That is, the code symbol generated in Step S35 includes the access information to the payment app server 7 in the site for operating the payment application and the amount information of the payment amount to be paid by the customer.

Next, in Step S36, the symbol display module 103 of the controller 100 displays the code symbol generated in Step S35 on the customer display 23. It should be noted that the controller 100 does not perform the processing in Step S35 in a case where the amount information is not added to the code symbol. In Step S36, the symbol display module 103 of the controller 100 displays the code symbol read in Step S34 on the customer display 23.

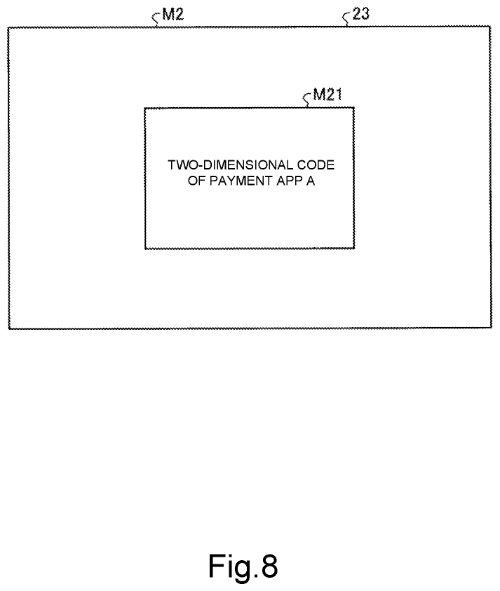

FIG. 8 is a diagram showing an example of the code symbol displayed in Step S36. As shown in FIG. 8, the symbol display module 103 of the controller 100 displays a screen M2 on the customer display 23. The symbol display module 103 deletes all the payment application images associated with the payment applications displayed in Step S32 on the screen M2. Instead, the symbol display module 103 displays only a code symbol M21 associated with the designated payment app A on the customer display 23 such that that an image of the code symbol M21 can be captured. Since the symbol display module 103 deletes all the payment application images associated with the payment applications displayed in Step S32, the code symbol M21 can be largely displayed on the customer display 23. Therefore, the customer can easily capture an image of the code symbol. Further, since only the code symbol M21 associated with the designated payment app A is displayed on the customer display 23, it is possible to prevent an image of the other code symbol from being erroneously captured.

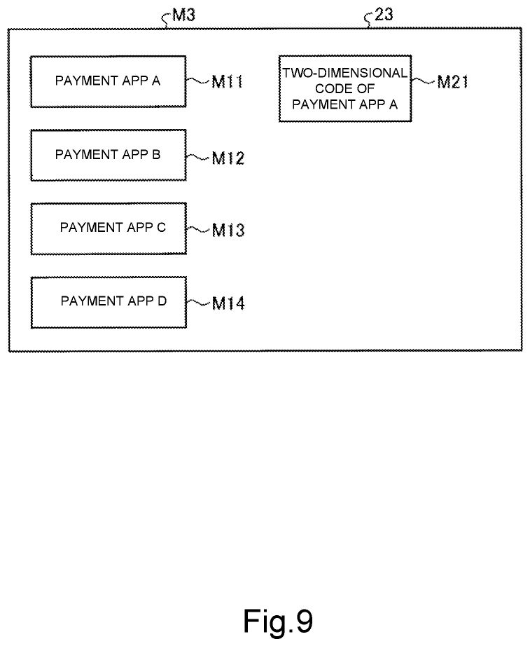

FIG. 9 is a diagram showing another example of the code symbol displayed in Step S36. As shown in FIG. 9, the symbol display module 103 of the controller 100 displays a screen M3 on the customer display 23. The symbol display module 103 displays the code symbol M21 associated with the designated payment app A at a position associated with the payment app A image M11 such that that an image of the code symbol M21 can be captured while the payment application images M11 to M14 associated with the payment applications displayed in Step S32 are still displayed on the screen M3. The position associated with the payment app A image M11 is a position on the right-hand side of the payment app A image M11 in the embodiment. Since the symbol display module 103 displays the code symbol M21 at the position associated with the payment application image associated with the designated payment application, the customer captures an image of the code symbol while confirming the designated payment app A. Further, since only the code symbol M21 associated with the designated payment app A is displayed on the customer display 23, it is possible to prevent an image of the other code symbol from being erroneously captured.

The customer captures an image of the code symbol displayed on the customer display 23 through the mobile terminal 5 and transmits the amount information to the payment app server 7 through the mobile terminal 5. Based on the received amount information, the payment app server 7 performs electronic processing (payment processing) of receiving the amount of money corresponding to the amount information from the bank account of the customer. Then, the payment app server 7 transmits the payment information (including the paid (withdrawn) amount) after the payment processing to the POS terminal 1.

The description of FIG. 6 will be continued. In Step S37, the controller 100 determines whether or not the payment information has been received from the payment app server 7. The controller 100 waits until the payment information is received from the payment app server 7 (No in Step S37). When the controller 100 determines that the payment information has been received from the payment app server 7 (YES in Step S37), the processing of the controller 100 proceeds to Step S38. In operation S38, the controller 100 performs payment processing of the POS terminal 1 on the basis of the commodity information stored in the commodity information unit 131 of the RAM 13. Moreover, the controller 100 activates the printing device 25 to issue a receipt on which the commodity information and the payment information are printed. Then, the processing of the controller 100 returns to Step S11.

It should be noted that in a case where the controller 100 determines in Step S21 that the payment key 211 has not been operated (No in Step S21), the processing of the controller 100 returns to Step S11. Further, in a case where the controller 100 determines in Step S22 that the terminal payment key 212 has not been operated (NO in Step S22), the processing of the controller 100 proceeds to Step S23. In Step S23, the controller 100 performs payment processing by the use of another medium such as cash and credit card as other payment processing. Then, the processing of the controller 100 returns to Step S11.

In accordance with the first embodiment described above, the POS terminal 1 includes the customer display 23 that displays information to the customer. The POS terminal 1 further includes the app display module 101 that displays, upon payment of the commodities to be purchased, the information regarding the plurality of types of usable payment applications on the customer display 23 in a recognizable manner. The POS terminal 1 further includes the designation determination module 102 that determines whether or not one payment application has been designated from the displayed payment applications. The POS terminal 1 further includes the symbol display module 103 that displays, on the customer display 23, the code symbol including at least information for accessing the payment app server 7 in the site of the payment application in a case where it is determined that one payment application has been designated. The POS terminal 1 according to the first embodiment described above displays the payment application that can be used at the store display 23 such that that the payment application can be recognized on the customer and also displays the code symbol associated with the designated payment application on the customer display 23. Therefore, the customer can easily recognize the payment application that can be used at the store. Further, in accordance with the first embodiment, the code symbol associated with the designated payment application is displayed on the customer display 23. Therefore, it is possible to prevent an image of the code symbol for the other payment application from being erroneously captured when capturing an image of the code symbol through the mobile terminal 5. Further, in a case where the code symbol displayed on the customer display 23 includes the amount information of the payment amount, it is not particularly necessary to enter the amount information of the payment amount in the mobile terminal 5.

### Second Embodiment

Hereinafter, a second embodiment will be described. In the first embodiment, only the code symbol associated with the designated payment application is displayed on the customer display 23, while in the second embodiment, code symbols associated with all payment applications that can be used at the store are displayed on the customer display 23. The configurations in connection with FIGS. 1 to 4 described in the first embodiment refer to similar configurations also in the second embodiment. It should be noted that in the description of the second embodiment, configurations similar to those of the first embodiment will be denoted by the same reference sings as the first embodiment and descriptions thereof will be omitted.

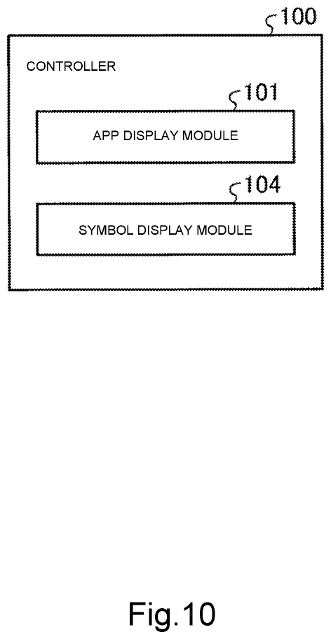

FIG. 10 is a functional block diagram showing a functional configuration of a POS terminal 1 according to the second embodiment. A controller 100 functions as an app display module 101 and a symbol display module 104 by executing a control program stored in a ROM 12 or a control program unit 141 of a memory device 14.

A app display module 101 of the controller 100 shown in FIG. 10 displays, upon payment of commodities to be purchased, information regarding one or more types of usable payment applications on a customer display 23 in a recognizable manner. Specifically, the app display module 101 reads payment application images associated with payment applications that can be used at the store from a payment app image unit 1432 of a terminal payment information unit 143 and displays the payment application images on the customer display 23 such that the customer can recognize the payment application images.

The symbol display module 104 of the controller 100 shown in FIG. 10 displays a code symbol including at least information for accessing sites of the payment applications in association with the payment applications on the same screen as the one or more types of displayed payment applications on the customer display 23. Specifically, the symbol display module 103 reads code symbols associated with the payment application images associated with the one or more payment applications displayed on the customer display from the payment app code unit 1433 of the terminal payment information unit 143. Then, the symbol display module 103 displays the read code symbols at positions on the customer display 23, the positions being associated with the payment application images. It should be noted that the symbol display module 104 favorably simultaneously displays the payment application images and the code symbols on the customer display 23.

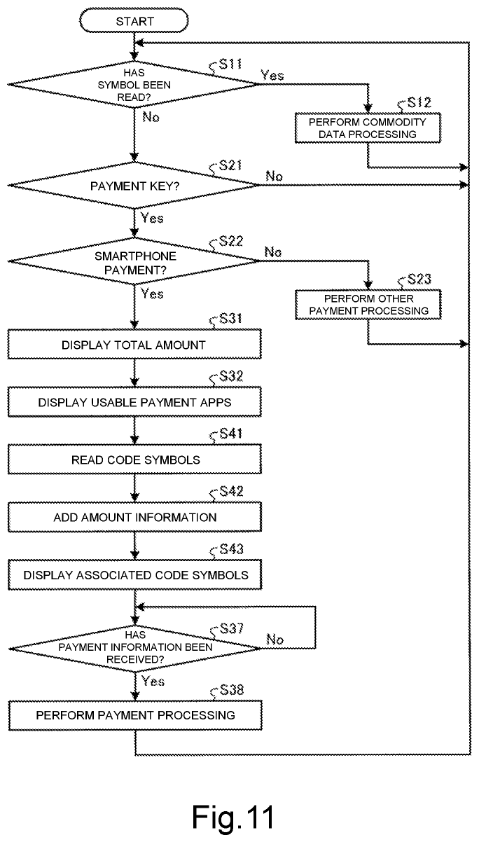

Hereinafter, the control of the POS terminal 1 according to the second embodiment will be described. FIG. 11 is a flowchart showing control processing of the POS terminal 1 according to the second embodiment. In FIG. 11, the processing of Step S11, Step S12, Step S21, Step S22, Step S23, Step S31, Step S32, Step S37, Step S38 are similar to the processing in the first embodiment.

In Step S41, following the processing in Step S31, the controller 100 reads the code symbols associated with all the payment applications that can be used at the store, which have been read in Step S32, from the payment app code unit 1433 of the terminal payment information unit 143. Then, in Step S42, the controller 100 generates code symbols to which the amount information of the payment amount to be paid by the customer is added for all the read code symbols. Then, the symbol display module 104 of the controller 100 displays the payment application images displayed in Step S32 and the code symbols generated in Step S42, at the positions at which those are associated with each other.

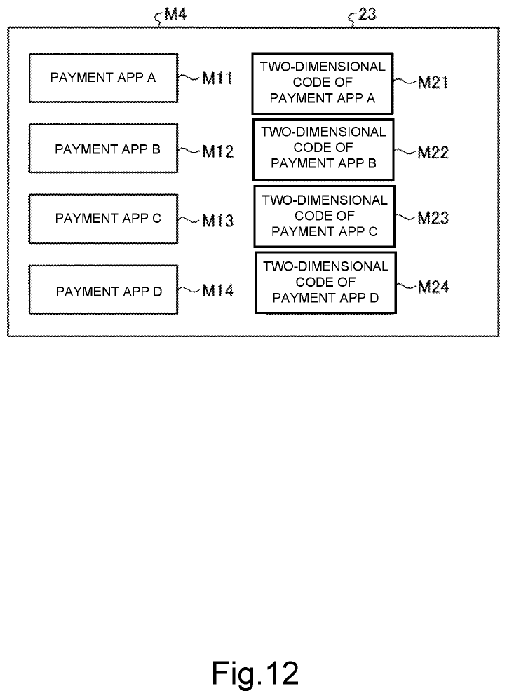

FIG. 12 is a diagram showing an example of a display screen of the customer display 23 of the POS terminal 1 according to the second embodiment. As shown in FIG. 12, a symbol display module 103 of the controller 100 displays a screen M4 on the customer display 23. The symbol display module 103 displays the payment application images associated with the payment applications displayed in Step S32 on the screen M4 on the customer display 23. Further, the symbol display module 103 displays a code symbol M21 associated with the displayed payment application image at a position associated with the payment application image such that an image of the code symbol M21 can be captured. The position associated with the payment application image is, in the embodiment, a position on the right-hand side of the payment application image. That is, the symbol display module 103 displays the code symbol M21 associated with a payment app A image M11 at the position associated with the payment app A image M11, i.e., at the position on the right-hand side of the payment app A image M11. Moreover, the symbol display module 103 displays a code symbol M22 associated with a payment app B image M12 at a position associated with the payment app B image M12, i.e., a position on the right-hand side of the payment app B image M12. Moreover, the symbol display module 103 displays a code symbol M23 associated with a payment app C image M13 at a position associated with the payment app C image M13, i.e., at a position on the right-hand side of the payment app C image M13. Moreover, the symbol display module 103 displays a code symbol M24 associated with a payment app D image M14 at a position associated with the payment app D image M14, i.e., at a position on the right-hand side of the payment app D image M14.

The customer captures an image of a code symbol displayed at the position associated with a payment application to be used through the mobile terminal 5. Specifically, for using the payment app A, the customer captures an image of the code symbol M21 through the mobile terminal 5. For using the payment app B, the customer captures an image of the code symbol M22 through the mobile terminal 5. For using the payment app C, the customer captures an image of the code symbol M23 through the mobile terminal 5. For using the payment app D, the customer captures an image of the code symbol M24 through the mobile terminal 5.

According to the second embodiment described above, the POS terminal 1 includes the customer display 23 that displays information to the customer. The POS terminal 1 further includes the app display module 101 that displays, upon payment of the commodities to be purchased, information regarding the one or more types of usable payment applications on the customer display 23 in a recognizable manner. The POS terminal 1 further includes the symbol display module 104 that displays the code symbol including at least the information for accessing the sites of the payment applications in association with the payment applications on the same screen as the displayed payment applications. The POS terminal 1 according to the second embodiment described above displays the payment applications that can be used at the store in a recognizable manner on the customer display 23 and also displays the code symbols at the positions associated with the displayed payment applications. Therefore, the customer can easily recognize the payment applications that can be used at the store. Further, in accordance with the second embodiment, the code symbols associated with the payment applications that can be used at the store are displayed on the customer display 23. Therefore, the customer can capture an image of the code symbol through the mobile terminal 5 while confirming the payment application to be used. Further, in a case where the code symbol displayed on the customer display 23 includes the amount information of the payment amount, it is not particularly necessary to enter the amount information of the payment amount in the mobile terminal 5.

For example, in the embodiment, the POS terminal 1 has been described as an example of the payment terminal. However, the present invention is not limited thereto, and for example, an check-out machine in a self POS terminal or a semi-self POS may be used as the payment terminal.

It should be noted that the program executed by the POS terminal 1 according to the embodiment is provided, recorded on a computer-readable recording medium such as a CD-ROM, a flexible disk (FD), a CD-R, and a digital versatile disk (DVD) in a file in an installable format or an executable format.

Alternatively, the program executed by the POS terminal 1 according to the embodiment may be provided by storing the program on a computer connected to a network such as the Internet and downloading it via a network. Alternatively, the program executed by the POS terminal 1 according to the embodiment may be provided or delivered via a network such as the Internet.

Alternatively, the program executed by the POS terminal according to the embodiment may be provided by being incorporated in advance in the ROM or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A payment terminal that performs commodity data processing for payment for a commodity to be purchased by a customer and payment processing for the commodity, the payment terminal comprising:
a display that displays information to the customer;
a memory device that stores information associated with one or more types of payment applications for payment, which are usable for the payment, and code symbols each including at least information for accessing a site of the payment application in association with each other; and
a controller that
reads, upon payment for the commodity, from the memory device the information associated with the one or more types of payment applications,
causes the display to display the read information associated with the payment application such that the customer is capable of recognizing the read information associated with the payment application,
determines whether or not one payment application has been designated from the displayed information associated with the payment application, and
reads, in a case of determining that the one payment application has been designated, from the memory device the code symbol associated with the payment application, and causes the display to display the read code symbol.

2. The payment terminal according to claim 1, wherein
the memory device stores payment application information for identifying the payment application and an application image distinctively showing the payment application in association with each other as the information associated with the payment application, and
the controller reads, upon payment for the commodity, the application image and causes the display to display the read application image.

3. The payment terminal according to claim 2, wherein
the controller determines whether or not one payment application has been designated by the customer from a payment application image displayed on the display.

4. The payment terminal according to claim 1, wherein
the controller causes, in a case of determining that the one payment application has been designated, the display to display the code symbol in place of the information associated with the payment application.

5. The payment terminal according to claim 4, wherein
the controller deletes, in a case of determining that the one payment application has been designated, all pieces of information associated with the payment application from a screen of the display and causes the display to display the code symbol.

6. The payment terminal according to claim 1, wherein
the code symbol includes amount information of a payment amount to be paid by the customer.

7. The payment terminal according to claim 1, wherein
the controller calculates a payment amount to be paid by the customer in accordance with the commodity data processing, generates a new code symbol in which amount information of the calculated payment amount is added to the read code symbol, and causes the display to display the generated code symbol.

8. A payment terminal that performs commodity data processing for payment for a commodity to be purchased by a customer and payment processing for the commodity, the payment terminal comprising:
a display that displays information to the customer;
a memory device that stores information associated with one or more types of payment applications for payment, which are usable for the payment, and code symbols each including at least information for accessing a site of the payment application in association with each other; and
a controller that
reads, upon payment for the commodity, from the memory device the information associated with the one or more types of payment applications and the code symbols,
causes the display to display the read information associated with the payment applications such that the customer is capable of recognizing the read information associated with the payment applications, and
causes the display to display the read code symbols in association with the information associated with the payment applications on a screen identical to a screen on which the information associated with the payment applications is displayed.

9. The payment terminal according to claim 1, wherein
the memory device stores the payment application information for identifying the payment applications and the application images distinctively showing the payment applications in association with each other as the information associated with the payment applications, and
the controller
reads, upon payment for the commodity, the application images and the code symbols, and causes the display to display the read application images, and
causes the display to display the read code symbols in association with the payment application images on the screen identical to the screen on which the application images are displayed.

10. A control method for a payment terminal that performs commodity data processing for payment for a commodity to be purchased by a customer and payment processing for the commodity, the control method comprising:
storing information associated with one or more types of payment applications for payment, which are usable for the payment, and code symbols each including at least information for accessing a site of the payment application in association with each other the memory device;
reading, upon payment for the commodity, from the memory device the information associated with the one or more types of payment applications and causing the display to display the read information associated with the payment application such that the customer is capable of recognizing the read information associated with the payment application;
determining whether or not one payment application has been designated from the displayed information associated with the payment application via the display; and
reading, in a case of determining that the one payment application has been designated, from the memory device the code symbol associated with the payment application and causing the display to display the read code symbol.
